(19) United States
(12) Patent Application Publication
(10) Pub. No.: US 2026/0084047 A1
(43) Pub. Date: Mar. 26, 2026

(54) OPERATING DEVICE

(71) Applicant: OMRON Corporation, KYOTO (JP)

(72) Inventors: Koichi FURUSAWA, Kyoto-shi, KYOTO (JP); Yasuhiro SAKASHITA, Kyoto-shi, KYOTO (JP)

(73) Assignee: OMRON Corporation, KYOTO (JP)

(21) Appl. No.: 19/112,601

(22) PCT Filed: Sep. 29, 2023
(86) PCT No.: PCT/JP2023/035609

§ 371 Date: Mar. 18, 2025

(30) Foreign Application Priority Data
Oct. 27, 2022 (JP) 2022-172654

(51) Int. Cl. A63F 13/24; A63F 13/285; G06F 3/01

(52) U.S. Cl. CPC A63F 13/24; A63F 13/285; G06F 3/016

(57) ABSTRACT

Provided is an operating device that is held or worn by an operator for operating an operation target. The operating device includes a rotating wheel that rotates with a rotation axis as a rotation center, and a motor that rotates the rotating wheel.

### TECHNICAL FIELD

The disclosure relates to an operating device that is held or worn by an operator for operating an operation target.

### RELATED ART

Various operating devices such as mouses and keyboards that are communicably connected to electronic devices such as game machines and computers for operating operation targets, have become widespread. In addition, as game content such as VR (virtual reality) and motion-sensing games etc. has diversified, operating devices of the type that are held or worn by the operator have become widespread (for example, Patent Document 1).

### CITATION LIST

### Patent Literature

Patent Document 1: Japanese Patent Application Laid-Open Publication No. 2020-91904
Non-Patent Document 1: Sky Technology Research Institute, “Sky Engineering Laboratory Blog: What is Gyro Moment? ˜ The Reason Why a Top Does Not Fall”, [Retrieved on Oct. 19, 2022], Internet, <URL: https://www.sky-engin.jp/blog/gyroscopic-moment/>

### SUMMARY OF INVENTION

### Technical Problem

Patent Document 1 discloses a controller for game operation. The controller of Patent Document 1 includes a vibrator inside, and may generate vibration in the controller by driving the vibrator. This allows force feedback to be given to make the operator's hand feel vibration while playing the game.

In recent years, game content such as VR and motion-sensing games etc. has come to demand more realistic reproduction of a sense of presence. However, force feedback by vibration of a vibrator has limited reproducibility of the sense of presence. For this reason, operating devices are also being required to provide a variety of force feedback capable of giving sensations other than vibration.

The disclosure has been made in view of the problem, and an object thereof is to provide an operating device capable of performing a variety of force feedback.

### Solution to Problem

To solve the problem, an operating device of the disclosure is an operating device held or worn by an operator for operating an operation target, and the operating device includes a rotation body that rotates with a rotation axis as a rotation center; and a rotational drive part that causes the rotation body to rotate with the rotation axis as a rotation center.

According to the configuration, by changing the posture or rotation speed of the rotation body that is rotated by the rotational drive part, inertial force in a specific direction may be generated. By utilizing this inertial force, a variety of force feedback (not just simple vibration) may be performed in the operating device.

In addition, the operating device may be configured such that the rotation body rotating with the rotation axis as a rotation center is made to be pivotable with a first pivot axis perpendicular to the rotation axis as a pivot center.

According to the configuration, by changing the posture of the rotation body, inertial force (gyro moment) in a specific direction may be generated.

In addition, the operating device may be configured such that the rotation body rotating with the rotation axis as a rotation center is made to be pivotable with a second pivot axis perpendicular to both the rotation axis and the first pivot axis as a pivot center.

According to the configuration, gyro moments may be generated in two different directions that are perpendicular to each other with respect to the rotation axis of the rotation body.

In addition, the operating device may be configured to include a first frame that supports the rotation body such that the rotation body is rotatable with the rotation axis as a rotation center; a second frame that supports the first frame such that the first frame is pivotable with the second pivot axis as a pivot center, and that is pivotable with the first pivot axis as a pivot center; and a guide frame that is pivotable with the first pivot axis as a pivot center, and, by transmitting its own pivoting to the first frame, is capable of causing the first frame to pivot with the second pivot axis as a pivot center.

According to the configuration, in the mechanism for generating the gyro moment, the influence of the self-weight of the driving source for pivoting the rotation body may be eliminated, making it possible to achieve highly responsiveness.

In addition, in the operating device, the rotational drive part may be configured to control a rotation direction and a rotation speed of the rotation body.

According to the configuration, in the mechanism for generating the gyro moment, by controlling the rotation direction and rotation speed of the rotation body, the function as a reaction wheel may also be provided.

In addition, in the operating device, the rotational drive part may be configured to control a rotation direction and a rotation speed of the rotation body, and the rotation body includes a plurality of rotation bodies having the rotation axes perpendicular to each other.

According to the configuration, by utilizing the rotation body and the rotational drive part as part of a reaction wheel so as to change the rotation speed of the rotation body, inertial force in a specific direction may be generated.

In addition, the operating device may be configured to include a first frame that supports the rotation body such that the rotation body is rotatable with the rotation axis as a rotation center; a second frame that supports the first frame such that the first frame is pivotable with the first pivot axis as a pivot center; and a third frame that supports the second frame such that the second frame is pivotable with the second pivot axis as a pivot center.

According to the configuration, in the case of providing the rotation body with the function of a momentum wheel, it becomes possible to arbitrarily set the direction of the rotation axis maintained by the momentum wheel.

### Effects of Invention

The operating device of the disclosure is capable of generating inertial force in a specific direction. By utilizing this inertial force, the effect is that a variety of force feedback (not just simple vibration) can be provided in the operating device.

### BRIEF DESCRIPTION OF DRAWINGS

FIG. 1 is a perspective diagram showing an appearance example of a game controller, which illustrates one embodiment of the operating device of the disclosure.

FIG. 2 is a functional block diagram of a game controller according to Embodiment 1.

FIG. 3 is a perspective diagram of the force feedback part according to Embodiment 1.

FIG. 4 is a side view of the force feedback part of FIG. 3 as viewed from the side of the second axis rotation motor.

FIG. 5 is a side view of the force feedback part of FIG. 3 as viewed from the side of the first axis rotation motor.

FIG. 6 is a diagram describing the gyro moment that may be generated by the force feedback part of FIG. 3.

FIG. 7 is a diagram describing the gyro moment that may be generated by the force feedback part of FIG. 3.

FIG. 8 is a diagram describing the gyro moment that may be generated by the force feedback part of FIG. 3.

FIG. 9 is a diagram describing the gyro moment that may be generated by the force feedback part of FIG. 3.

FIG. 10 is a perspective diagram showing another embodiment of the operating device of the disclosure, illustrating an appearance example of a game controller.

FIG. 11 is a functional block diagram of a game controller according to Embodiment 2.

FIG. 12 is a perspective diagram of the force feedback part according to Embodiment 2.

FIG. 13 is a perspective diagram of the force feedback part according to Embodiment 4.

FIG. 14 is a perspective diagram showing an example of the operating device according to Embodiment 5.

FIG. 15 is a diagram showing an electric lawn mower as another application example of the force feedback part.

### DESCRIPTION OF THE EMBODIMENTS

### Embodiment 1

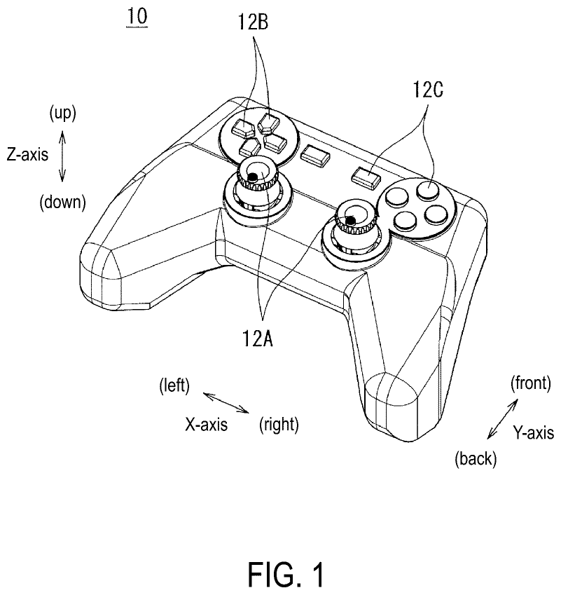

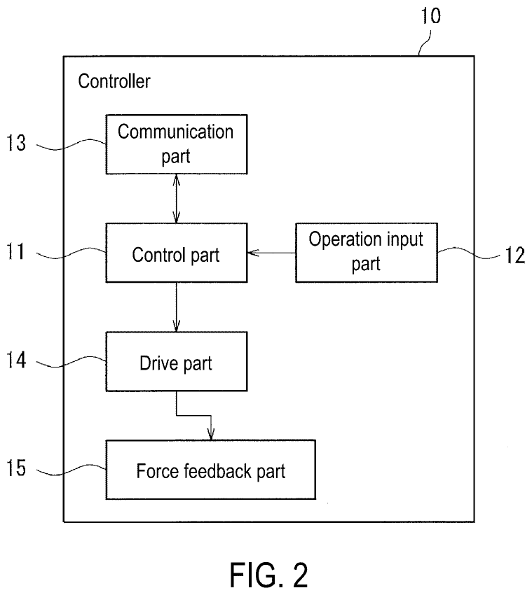

The following describes in detail the embodiments of the operating device of the disclosure with reference to the drawings. In this Embodiment 1, a case where the operating device of the disclosure is applied to a game controller is exemplified. FIG. 1 is a perspective diagram showing an appearance example of a game controller (hereinafter simply referred to as a controller) 10 according to Embodiment 1. FIG. 2 is a functional block diagram of the controller 10.

The controller 10 exemplified in FIG. 1 is designed to be held and operated with both hands by the operator, and includes an operation input part 12 (operation stick 12A, cross button 12B, key button 12C, etc.) for the operator to perform operation inputs. For ease of description, the directions of the three orthogonal axes (X-axis, Y-axis and Z-axis) shown in FIG. 1 correspond respectively to the left-right direction, front-back direction and up-down direction of the controller 10.

The controller 10 includes, as shown in FIG. 2, a control part 11, an operation input part 12, a communication part 13, a drive part 14, and a force feedback part 15. The communication part 13 is a means for the controller 10 to communicate with the game machine body (not shown) wirelessly or via wire. The force feedback part 15 is built into the controller 10 as a means for receiving drive from the drive part 14 and giving feedback that allows the operator holding the controller 10 to sense a force. The control part 11 is a means to perform overall control of the controller 10 (processing control of input signals from the operation input part 12, communication control with the game machine body via the communication part 13, drive control of the drive part 14).

In the controller 10, the force feedback part 15 is not a means for simply generating vibration like a conventional vibrator, but is capable of generating force that allows the operator to sense a force being applied in a specific direction due to inertial force. In this Embodiment 1, a force feedback part 15 utilizing a gyro moment is exemplified.

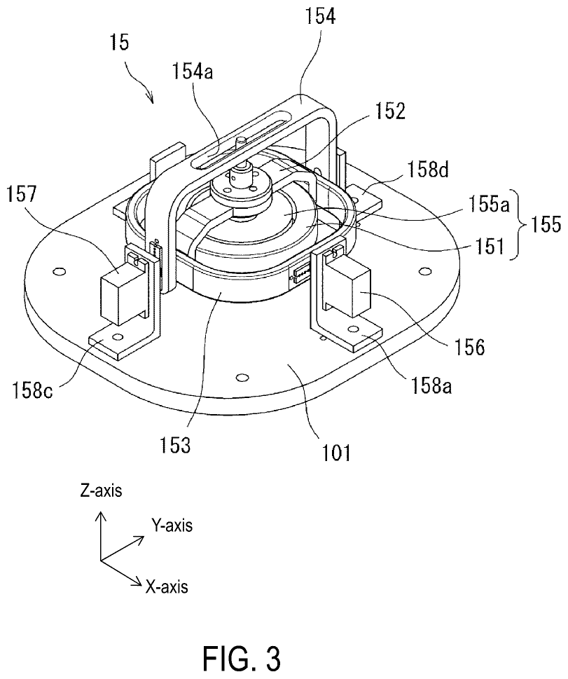

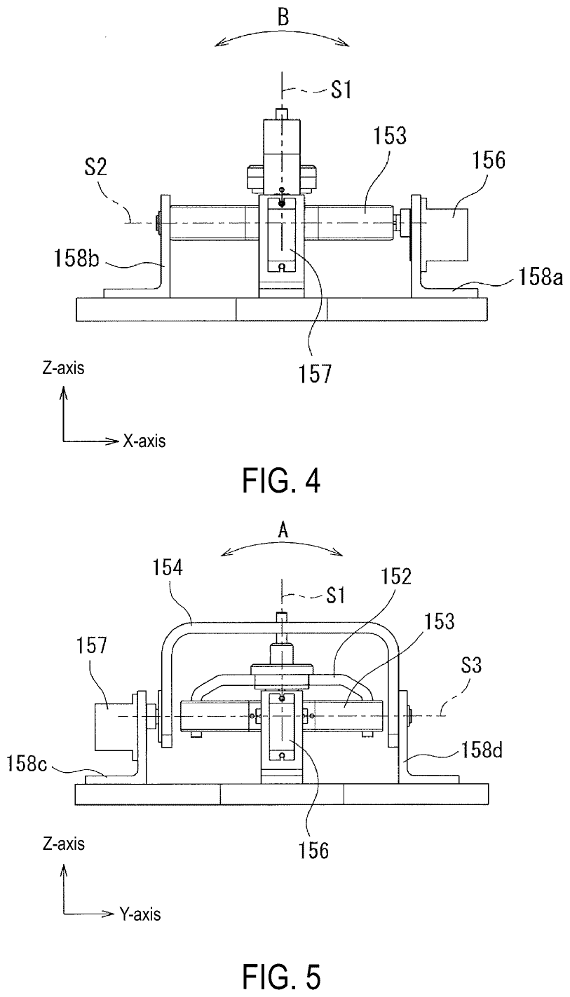

FIG. 3 is a perspective diagram of the force feedback part 15. FIG. 4 is a side view of the force feedback part 15 as viewed from a second axis rotation motor 157 side. FIG. 5 is a side view of the force feedback part 15 as viewed from a first axis rotation motor 156 side.

The force feedback part 15, as shown in FIG. 3 to FIG. 5, includes a rotating wheel (rotation body) 151, an inner frame (first frame) 152, a middle frame (second frame) 153, and a guide frame 154 as the main components of the mechanism for generating gyro moment. Moreover, the force feedback part 15 includes a motor (rotational drive part) 155, a first axis rotation motor 156, and a second axis rotation motor 157 as components corresponding to the drive part 14 in FIG. 2, and further includes support legs 158a to 158d for fixing the force feedback part 15 to a foundation 101. Further, a motor 155 is configured with a rotating wheel 151 as the rotor and a stator 155a inside the rotor. In addition, in the force feedback part 15, the support legs 158a and 158b that support a rotation axis S2 of the middle frame 153, which will be described later, function as an outer frame. In FIG. 3 to FIG. 5, for convenience, the foundation 101 to which the force feedback part 15 is attached is depicted as a flat plate, but the foundation 101 may be part of the frame member of the controller 10.

The rotating wheel 151 is supported by the inner frame 152, and is capable of rotational drive around a rotation axis S1 (refer to FIG. 4 and FIG. 5) by the motor 155 attached to the inner frame 152. Moreover, both ends of the inner frame 152 are rotatably attached to the middle frame 153.

The middle frame 153 is supported by two opposing support legs 158a and 158b, and is capable of pivoting (pivoting in the direction of arrow A in FIG. 5) around the rotation axis S2 (first pivot axis: refer to FIG. 4) by the first axis rotation motor 156. Moreover, the first axis rotation motor 156 is a servo motor or stepping motor used for pivot control of the middle frame 153, and is fixedly attached to the support leg 158a.

When the middle frame 153 pivots in the direction of arrow A, the inner frame 152 attached to the middle frame 153, and the rotating wheel 151 supported by the inner frame 152 also pivot simultaneously in the direction of arrow A. Here, pivoting refers to a rotational motion that is possible in both directions with a limited angular range. In other words, in the force feedback part 15, the middle frame 153 and the first axis rotation motor 156 have the role of changing the inclination of the rotation axis S1 of the rotating wheel 151 along the direction of arrow A.

The guide frame 154 is supported by two opposing support legs 158c and 158d, and is capable of pivoting (pivoting in the direction of arrow B in FIG. 4) around a rotation axis S3 (second pivot axis: refer to FIG. 5) by the second axis rotation motor 157. Moreover, the second axis rotation motor 157 is a servo motor or stepping motor used for pivot control of the guide frame 154, and is fixedly attached to the support leg 158c.

The guide frame 154 has a guide hole 154a formed in an elongated hole shape with its longitudinal direction parallel to the rotation axis S3, and one end of the rotation axis member of the rotating wheel 151 is inserted through the guide hole 154a. When the guide frame 154 pivots in the direction of arrow B, the rotating wheel 151 receives force through the rotation axis member inserted in the guide hole 154a. As a result, when the guide frame 154 pivots in the direction of arrow B, the rotating wheel 151 and the inner frame 152 also pivot simultaneously in the direction of arrow B. In other words, in the force feedback part 15, the guide frame 154 and the second axis rotation motor 157 have the role of changing the inclination of the rotation axis S1 of the rotating wheel 151 along the direction of arrow B.

Moreover, when the rotating wheel 151 pivots in the direction of arrow B, the inner frame 152 supporting the rotating wheel 151 pivots relative to the middle frame 153. As a result, the middle frame 153 does not interfere with the pivoting of the rotating wheel 151 in the direction of arrow B. On the other hand, when the rotating wheel 151 pivots in the direction of arrow A, the rotation axis member of the rotating wheel 151 moves along the guide hole 154a. As a result, the guide frame 154 does not interfere with the pivoting of the rotating wheel 151 in the direction of arrow A.

In the force feedback part 15, an initial state is defined as a state where the rotation axis S1 of the rotating wheel 151 is arranged parallel to the Z-axis (up-down direction). Moreover, in the initial state of the force feedback part 15, the rotation axis S2 is arranged parallel to one of the X-axis and Y-axis of the controller 10 (in the example of FIG. 3 to FIG. 5, the X-axis), and the rotation axis S3 is arranged parallel to the other of the X-axis and Y-axis (in the example of FIG. 3 to FIG. 5, the Y-axis).

In the force feedback part 15 with the above-described configuration, with the rotating wheel 151 rotated at high speed by the motor 155, by changing the inclination of the rotation axis S1 of the rotating wheel 151 using the first axis rotation motor 156 or the second axis rotation motor 157, an inertial rotational force (so-called gyro moment) may be generated.

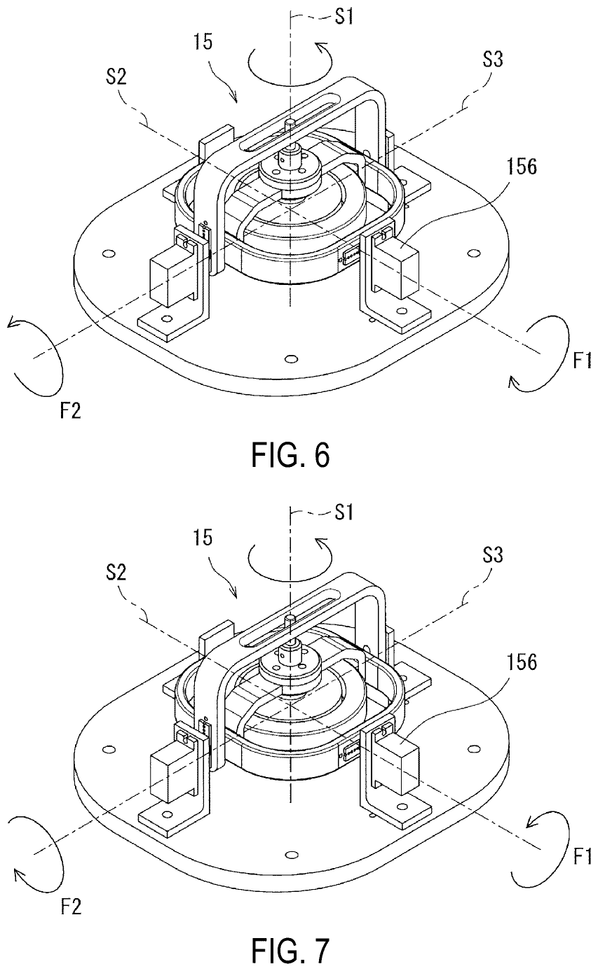

FIG. 6 to FIG. 9 are diagrams illustrating the gyro moment that may be generated by the force feedback part 15. Moreover, in FIG. 6 to FIG. 9, a pivot force applied by the first axis rotation motor 156 or the second axis rotation motor 157 is denoted as F1, and a resulting gyro moment generated in the force feedback part 15 is denoted as F2. Moreover, the rotation direction of the rotating wheel 151 at this time is counterclockwise when viewed from the top side of the controller 10.

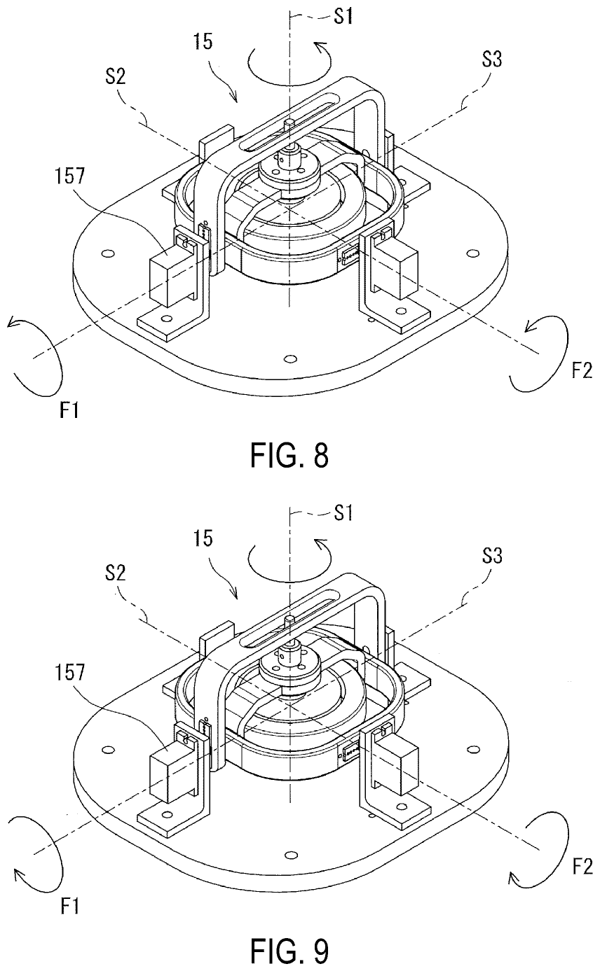

As shown in FIG. 6, in the case where a pivot force F1 in a forward rotation direction (clockwise direction when viewed from the right side of the controller 10) is applied around the rotation axis S2 by the first axis rotation motor 156, a gyro moment F2 in the leftward rotation direction (counterclockwise direction when viewed from the back side of the controller 10) is generated around the rotation axis S3. As shown in FIG. 7, in the case where a pivot force F1 in the backward rotation direction (counterclockwise direction when viewed from the right side of the controller 10) is applied around the rotation axis S2 by the first axis rotation motor 156, a gyro moment F2 in the rightward rotation direction (clockwise direction when viewed from the back side of the controller 10) is generated around the rotation axis S3. As shown in FIG. 8, in the case where a pivot force F1 in the leftward rotation direction is applied around the rotation axis S3 by the second axis rotation motor 157, a gyro moment F2 in the backward rotation direction is generated around the rotation axis S2. And as shown in FIG. 9, in the case where a pivot force F1 in the rightward rotation direction is applied around the rotation axis S3 by the second axis rotation motor 157, a gyro moment F2 in the forward rotation direction is generated around the rotation axis S2.

Further, the gyro moment F2 shown in FIG. 6 to FIG. 9 is expressed by the following equation (1). In other words, when applying equation (1) to the examples in FIG. 6 to FIG. 9, a coordinate system O-xyz is considered in which an axisymmetric rigid body (in this case, the rotating wheel 151) is rotating around a fixed point or a point O, which is the center of gravity, on the axis of symmetry (in this case, the Z-axis), and the coordinate system has no angular velocity around the axis of symmetry of the rigid body. The coordinate system O-xyz is an intermediate coordinate system that rotates in conjunction with the rigid body around the X-axis and Y-axis, but does not rotate around the Z-axis. In equation (1), let Ia be the moment of inertia around the axis of symmetry (Z-axis) of the rigid body (rotating wheel 151), and ωx, ωy, Ω be the angular velocities around the X-axis, Y-axis, and Z-axis respectively. Then, an apparent moment (i.e. gyro moment) M_{gyro} (in this case, gyro moment F2) is generated in the coordinate system O-xyz. The principle of gyro moment generation and calculation formula are known, as disclosed in, for example, non-patent literature 1, so detailed description is omitted here.

$$[ Equation 1 ]$$

$${M}_{gyro} = [ \begin{matrix}0 \\ - {I}_{a} {Ωω}_{x} \\ {I}_{a} {Ωω}_{y}\end{matrix} ] \qquad ( 1 )$$

In the controller 10, the gyro moment generated in the force feedback part 15 can provide feedback that makes the operator feel a force in his or her hand. As described above, the generated gyro moment gives a rotational force with a specific direction to the operator's hand, and may be generated in multiple directions. As a result, the controller 10 equipped with the force feedback part 15 is capable of performing a variety of force feedbacks. For example, in the case of playing a racing game, by generating a gyro moment in the leftward and rightward rotation directions, it is possible to imitate the rotational reaction force of a steering wheel.

In addition, in the above-described force feedback part 15, pivot control is performed on the inner frame 152, middle frame 153, and guide frame 154 to generate the pivot force F1. However, the first axis rotation motor 156 and the second axis rotation motor 157, which are the driving sources for this pivot control, do not displace together with these frames. In particular, the second axis rotation motor 157 needs to transmit the pivot force to the inner frame 152 from the outside of the middle frame 153, but by adopting a configuration that transmits the pivot force to the inner frame 152 via the guide frame 154, it becomes unnecessary to attach the second axis rotation motor 157 to the middle frame 152. As a result, the force feedback part 15 is capable of pivoting the inner frame 152, the middle frame 153, and the guide frame 154 without being affected by the self-weight of the first axis rotation motor 156 and the second axis rotation motor 157, making it possible to achieve high responsiveness.

### Embodiment 2

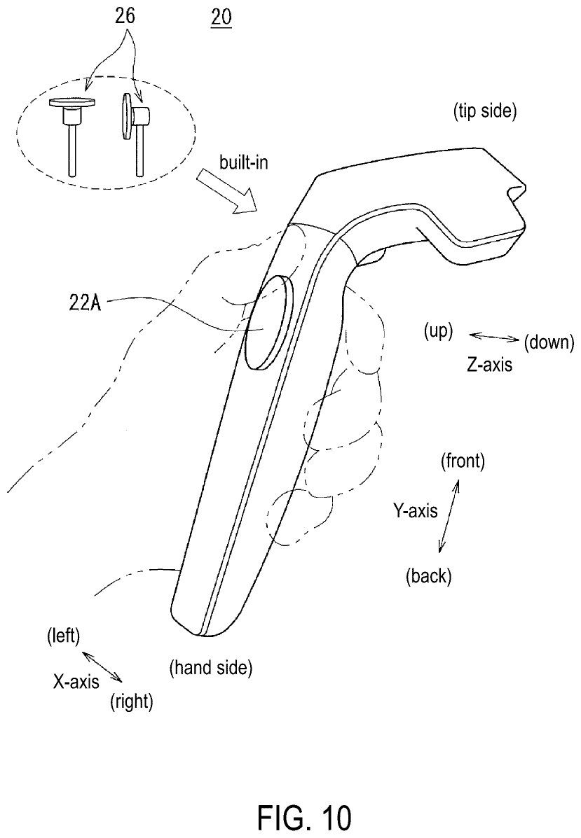

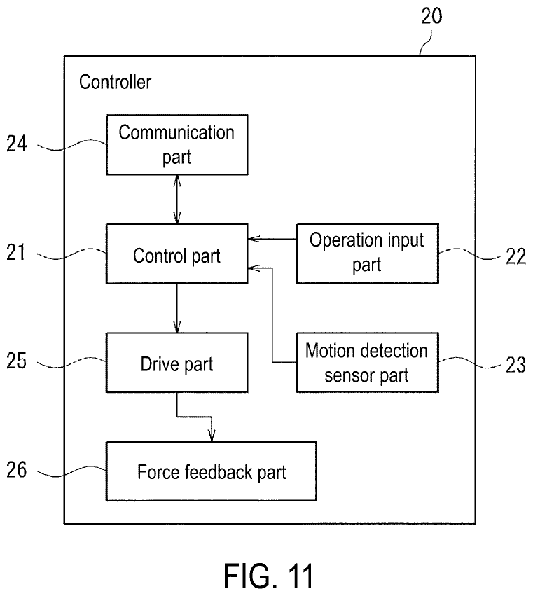

This Embodiment 2 illustrates an example of applying the operating device of the disclosure to a game controller different from that in Embodiment 1. FIG. 10 is a perspective diagram showing an appearance example of a game controller (hereinafter simply referred to as a controller) 20 according to this Embodiment 2. FIG. 11 is a functional block diagram of a controller 20.

The controller 20 exemplified in FIG. 10 has a stick shape with a longitudinal direction, and is operated by the operator holding one end (the hand-side) of the stick with one hand and swinging the controller itself. Moreover, the controller 20 also includes an operation input part 22 for the operator to perform operation input, and the operation input part 22 includes an operation means 22A (which is a button in FIG. 10, but may also have a stick) intended for thumb operation. For ease of description, the posture with the operation means 22A facing upward is taken as the basic posture, and the directions of the three orthogonal axes (X-axis, Y-axis, and Z-axis) shown in FIG. 10 correspond respectively to the left-right direction, front-back direction, and up-down direction of the controller 20.

The controller 20, as shown in FIG. 11, includes a control part 21, an operation input part 22, a motion detection sensor part 23, a communication part 24, a drive part 25, and a force feedback part 26. The motion detection sensor part 23 is a means for detecting the movement of the controller 20 swung by the operator, and includes sensors such as inclination sensors and acceleration sensors. In the controller 20, the detection signal from the motion detection sensor part 23 is used as an operation input signal by the operator. The communication part 24 is a means for the controller 20 to communicate with the game machine body (not shown) wirelessly or via wire. The force feedback part 26 is built into the controller 20 as a means for receiving the drive from the drive part 25 and giving feedback that allows the operator holding the controller 20 to sense a force. The control part 21 is a means for performing overall control of the controller 20 (processing control of input signals from the operation input part 22, communication control with the game machine body via the communication part 24, drive control of the drive part 25).

In the controller 20, the force feedback part 26 is not a means for simply generating vibration like a conventional vibrator, but is capable of generating force that allows the operator to sense a force being applied in a specific direction due to inertial force. In this Embodiment 2, a force feedback part 26 utilizing a reaction wheel is exemplified.

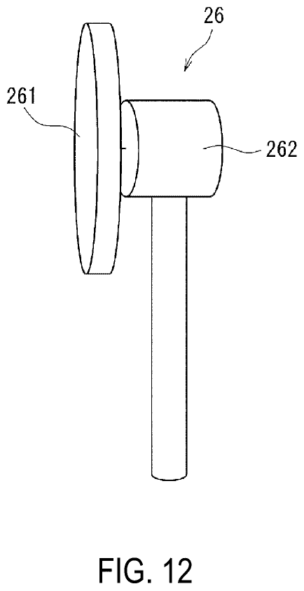

FIG. 12 is a perspective diagram of the force feedback part 26. As shown in FIG. 12, the force feedback part 26 includes a flywheel (rotation body) 261 and a servo motor (rotational drive part) 262 corresponding to the drive part 25 in FIG. 11. Moreover, 262 may also be a stepping motor.

In the force feedback part 26, a servo motor 262 performs rotational drive of the flywheel 261, and feedback may be given that allows the operator to sense a force in their hand due to the rotational reactive force generated in response to accelerating (including rotation from a stop) or decelerating (including stopping from rotation) the rotation of the flywheel 261. Specifically, in response to accelerating the flywheel 261, the servo motor 262 receives force in the direction opposite to the rotation direction of the flywheel 261. Moreover, in response to decelerating the flywheel 261, the servo motor 262 receives force in the same direction as the rotation direction of the flywheel 261.

In the controller 20, by placing the force feedback part 26 near the tip of the controller 20 and arranging the rotation axis of the flywheel 261 to be perpendicular to the longitudinal axis of the controller 20, force may be applied to the operator's hand in a specific direction. Specifically, by aligning the rotation axis of the flywheel 261 with the Z-axis direction (up-down direction) in FIG. 10, force may be applied to the operator's hand in the Y-axis direction (left-right direction). Further, by aligning the rotation axis of the flywheel 261 with the Y-axis direction in FIG. 10, force may be applied to the operator's hand in the Z-axis direction.

Moreover, the acceleration or deceleration of the flywheel 261 may be performed continuously or intermittently. This allows, for example, simulating the pull of a fishing rod when playing a fishing game. Moreover, the magnitude of the force applied to the operator's hand varies according to the magnitude of the acceleration of the flywheel 261. Furthermore, the controller 20 may incorporate multiple force feedback parts 26 having rotation axes of the flywheels 261 oriented differently from each other (more specifically, with their respective rotation axes perpendicular to each other), as shown in FIG. 10. In this case, various directional forces may be generated in a single controller 20.

In addition, in the Embodiment 2, while an example of mounting the force feedback part 26 utilizing a reaction wheel on a single-handed type controller 20 is illustrated, it is also possible to mount the force feedback part 26 on a two-handed type controller 20. Similarly, the force feedback part 15 utilizing gyro moment may be mounted not only on the two-handed type controller 10 but also on the single-handed type controller 20. Moreover, the force feedback part 15 utilizing gyro moment may also function as a reaction wheel by increasing or decreasing the rotation speed of the rotating wheel 151. In this case, by adding one axis by the reaction wheel to the two axes by the gyro moment, rotational force in three axes may be obtained. Furthermore, it is possible to mount the force feedback part 15 or the force feedback part 26 on a type of controller that is worn directly on the operator's body. As an example of the wearable type controller, a controller that is worn on the operator's hand like a glove may be considered.

### Embodiment 3

In the above embodiments 1 and 2, a configuration in which the rotation body (rotating wheel 151 or flywheel 261) is combined with only the drive part (motor 155 or servo motor 262) that rotationally drives the rotation body. However, the disclosure is not limited thereto, and it is also possible to combine the rotation body with a brake that abruptly stops the rotation of the rotation body. In this case, MR fluid (Magnetorheological fluid) brakes or ER fluid (electrorheological fluid) brakes may be suitably configured as the brakes.

For example, in the force feedback part 26 described in Embodiment 2, a configuration in which a brake (not shown) is attached to the rotation axis of the flywheel 261 may be considered. In this configuration, by rotating the flywheel 261 at high speed and instantly stopping its rotation using the brake, it is possible to make operator experience a sensation close to an impact. This allows, for example, simulating the sensation of hitting back a ball (when the ball hits the racket) in response to playing a tennis game.

Moreover, the sensation of impact by stopping rotation using a brake may also be applied to the force feedback part 15 described in Embodiment 1. In this case, the brake may be provided for any of the rotation axes S1 to S3, but it is particularly suitable to provide it for the rotation axis S1. Specifically, the rotation axis S1 is the rotation axis of the rotating wheel 151, and by providing a brake on it, the rotating wheel 151 rotating at high speed may be instantly stopped, generating a sensation close to an impact.

### Embodiment 4

This embodiment 4 illustrates a force feedback part 31 that may be used as a momentum wheel. In a momentum wheel, a high-speed rotating wheel generates an action to maintain its rotation axis.

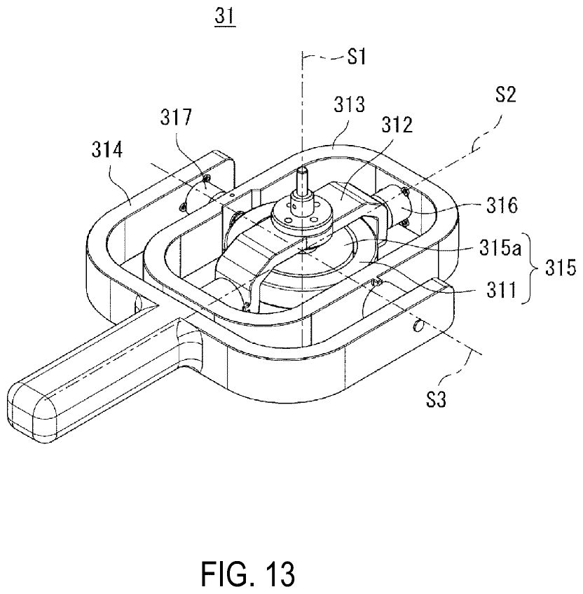

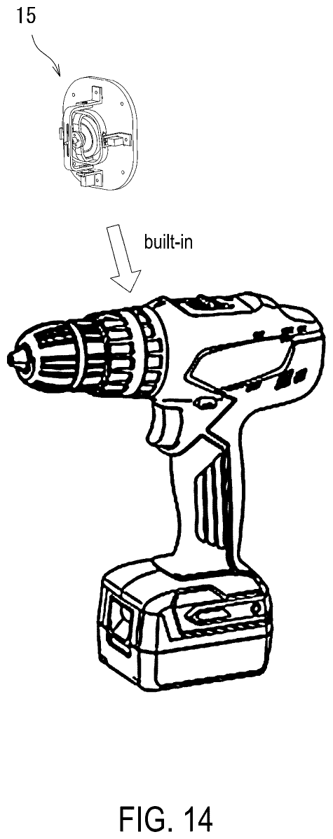

FIG. 13 is a perspective diagram of the force feedback part 31. As shown in FIG. 13, the force feedback part 31 includes a rotating wheel (rotation body) 311, an inner frame (first frame) 312, a middle frame (second frame) 313, an outer frame (third frame) 314, a motor (rotational drive part) 315, a first axis rotation motor 316, and a second axis rotation motor 317. A motor 315 is configured with the rotating wheel 311 as a rotor and a stator 315a inside the rotor. Servo motors or stepping motors are used for the first axis rotation motor 316 and the second axis rotation motor 317.

In the force feedback part 31, the inner frame 312 supports the rotating wheel 311 such that the rotating wheel 311 is rotatable around the rotation axis S1. Moreover, the motor 315 for rotationally driving the rotating wheel 311 is also fixed in the inner frame 312. The middle frame 313 supports the inner frame 312 such that the inner frame 312 is pivotable around the rotation axis S2 (first pivot axis). Moreover, the first axis rotation motor 316 for pivotally displacing the inner frame 312 relative to the middle frame 313 is also fixed in the middle frame 313. The outer frame 314 supports the middle frame 313 such that the middle frame 313 is pivotable around the rotation axis S3 (second pivot axis). Moreover, the second axis rotation motor 317 for pivotally displacing the middle frame 313 relative to the outer frame 314 is also fixed in the outer frame 314.

In the force feedback part 31, by rotating the rotating wheel 311 at high speed using the motor 315, an inertial force that tries to maintain the direction (inclination) of the rotation axis S1 may be generated. In the case where this force feedback part 31 is mounted on, for example, a game controller (controller 10 or 20), the outer frame 314 is attached to be fixed to the frame member of the controller.

In a controller equipped with the force feedback part 31, when the controller is moved (including at least a movement that pivotally displaces the controller) by the operator during operation of the force feedback part 31 (while the rotating wheel 311 is rotating), an inertial force is generated in the direction that tries to restore the direction of the rotation axis S1 against the movement of the controller, and this inertial force becomes the force feedback to the operator. In other words, while the aforementioned force feedback parts 15, 26 may actively provide force feedback from the controller side using the effects of gyro moment or reaction wheel, the force feedback part 31 by the effect of a momentum wheel may provide passive force feedback when a movement is applied to the controller from the operator's side.

In addition, in the force feedback part 31, it is possible to change the direction of the rotation axis S1 by pivoting the inner frame 312 using the first axis rotation motor 316 or pivoting the middle frame 313 using the second axis rotation motor 317. In other words, in a controller equipped with the force feedback part 31, it is possible to set the direction of the rotation axis S1, which it tries to maintain, to any desired direction.

In addition, in the aforementioned force feedback parts 15, 16, it is also possible to make the rotating wheel 151 or the flywheel 261 function as a momentum wheel by rotating them at high speed.

### Embodiment 5

In the above Embodiments 1 to 4, examples were given where the operating device of the disclosure is applied to a game controller. However, the application of the operating device of the disclosure is not limited to game controllers, and it may be applied to various other devices.

As an example, it is possible to apply the force feedback part 15 utilizing gyro moment to electric tools such as handheld drills. In drilling operations using a handheld drill, it is important to maintain the posture such that the angle of the drill's rotation axis does not change. In this case, the force feedback part 15 is arranged such that the rotation axis S1 of the rotating wheel 151 is parallel to the rotation axis of the drill, and when the posture of the handheld drill deviates (when the rotation axis of the drill is inclined), the aforementioned gyro moment may be generated in the force feedback part 15, which may be used as a rotational force to correct that deviation.

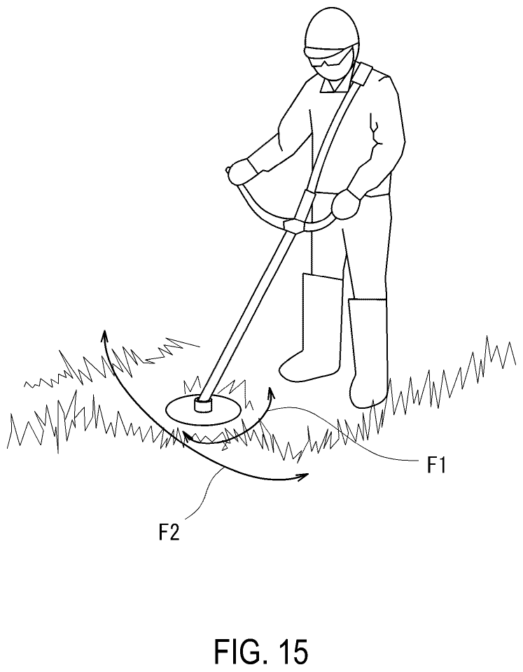

As another example, it is conceivable to apply the force feedback part 15 to an electric lawn mower as shown in FIG. 15. In this case, by applying a force F1 that swings the rotating disc for cutting grass back and forth about a pivot point (rotation center of the disc), it is possible to generate a force F2 that swings the rotating disc left and right, thus obtaining a force that supports the operation. As a specific example, by attaching an actuator to the disc part that makes the disc swing back and forth, and making only the disc swing back and forth, it is possible to make the disc swing left and right using the part in contact with the body as a pivot point.

The embodiments disclosed herein are exemplary in all aspects and should not be construed as limiting. Therefore, the technical scope of the disclosure should not be interpreted solely based on the above-described embodiments, but should be defined based on the description in the claims. Furthermore, all modifications within equivalent meanings and scopes of the claims are included.

This application claims priority based on Japanese Patent Application No. 2022-172654 filed with the Japan Patent Office on Oct. 27, 2022, and the entire content of Japanese Patent Application No. 2022-172654 is incorporated herein by reference.

### REFERENCE SIGNS LIST

10, 20 Game controller (operating device)
11, 21 Control part
12, 22 Operation input part
13, 24 Communication part
14, 25 Drive part
15, 26, 31 Force feedback part
151 Rotating wheel (rotation body)
152, 312 Inner frame (first frame)
153, 313 Middle frame (second frame)
154 Guide frame
155, 315 Motor (rotational drive part)
156, 316 First axis rotation motor
157,317 Second axis rotation motor
158a-158d Support leg
23 Motion detection sensor part
261 Flywheel (rotation body)
262 Servo motor (rotational drive part)
314 Outer frame (third frame)

1. An operating device held or worn by an operator for operating an operation target, the operating device comprising:
a rotation body that rotates with a rotation axis as a rotation center; and
a rotational drive part that causes the rotation body to rotate with the rotation axis as a rotation center.

2. The operating device according to claim 1, wherein
the rotation body rotating with the rotation axis as a rotation center is made to be pivotable with a first pivot axis perpendicular to the rotation axis as a pivot center.

3. The operating device according to claim 2, wherein
the rotation body rotating with the rotation axis as a rotation center is made to be pivotable with a second pivot axis perpendicular to both the rotation axis and the first pivot axis as a pivot center.

4. The operating device according to claim 3, comprising:
a first frame that supports the rotation body such that the rotation body is rotatable with the rotation axis as a rotation center;
a second frame that supports the first frame such that the first frame is pivotable with the second pivot axis as a pivot center, and that is pivotable with the first pivot axis as a pivot center; and
a guide frame that is pivotable with the first pivot axis as a pivot center, and, by transmitting its own pivoting to the first frame, is capable of causing the first frame to pivot with the second pivot axis as a pivot center.

5. The operating device according to claim 2, wherein
the rotational drive part is capable of controlling a rotation direction and a rotation speed of the rotation body.

6. The operating device according to claim 1, wherein
the rotational drive part is capable of controlling a rotation direction and a rotation speed of the rotation body, and
the rotation body comprises a plurality of rotation bodies having the rotation axes perpendicular to each other.

7. The operating device according to claim 3, wherein
a first frame that supports the rotation body such that the rotation body is rotatable with the rotation axis as a rotation center;
a second frame that supports the first frame such that the first frame is pivotable with the first pivot axis as a pivot center; and
a third frame that supports the second frame such that the second frame is pivotable with the second pivot axis as a pivot center.

8. The operating device according to claim 3, wherein
the rotational drive part is capable of controlling a rotation direction and a rotation speed of the rotation body.

9. The operating device according to claim 4, wherein
the rotational drive part is capable of controlling a rotation direction and a rotation speed of the rotation body.
